(19) United States
(12) Patent Application Publication
(10) Pub. No.: US 2015/0160057 A1
(43) Pub. Date: Jun. 11, 2015

(54) SYSTEMS AND METHODS FOR DETERMINING MASS FLOW MEASUREMENTS OF FLUID FLOWS

(71) Applicant: Yokogawa Corporation of America, Sugar Land, TX (US)

(72) Inventor: Tadao Jo, Missouri City, TX (US)

(73) Assignee: Yokogawa Corporation of America, Sugar Land, TX (US)

(21) Appl. No.: 14/101,976

(22) Filed: Dec. 10, 2013

(51) Int. Cl. G01F 1/88; G01F 1/44; G01F 1/90; G01F 1/32; G01F 1/56; G01F 1/34; G01F 1/42

(52) U.S. Cl. CPC G01F 1/88; G01F 1/34; G01F 1/44; G01F 1/42; G01F 1/3209; G01F 1/56; G01F 1/90

(57) ABSTRACT

The disclosure generally relates to flow meters and more particularly relates to systems and methods for determining, among other things, mass flow measurements of fluids. In certain embodiments, a system may include a pipe having a fluid flow therethrough, a first flow meter coupled to the pipe, and a second flow meter coupled to the pipe in series with the first flow meter. The system also may include a computer in communication with the first flow meter and the second flow meter. The computer may be configured to receive fluid flow information from the first flow meter; receive fluid flow information from the second flow meter; and determine, based at least in part on the fluid flow information from the first flow meter and the fluid flow information from the second flow meter, a mass flow measurement of the fluid flow.

### TECHNICAL FIELD

The disclosure generally relates to flow meters and more particularly relates to systems and methods for determining mass flow measurements of fluid flows.

### BACKGROUND

In the oil and gas industry, to measure mass flow of a fluid (e.g., gas or liquid), density or molecular weight of the fluid is used. That is, if the density of the fluid is known, it can be used to determine the mass flow rate of the fluid. Fluid density may fluctuate based on varying fluid compositions or properties. As a result, current techniques for measuring fluid density are expensive, slow, and not suitable for mass flow control of a variable composition gas and/or liquid.

### BRIEF DESCRIPTION OF THE FIGURES

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 schematically depicts an example system for determining, among other things, a mass flow measurement of a fluid flow in accordance with one or more embodiments of the disclosure.

FIG. 2 schematically depicts an example system for determining, among other things, a mass flow measurement of a fluid flow in accordance with one or more embodiments of the disclosure.

FIG. 3 schematically depicts an example system for determining, among other things, a mass flow measurement of a fluid flow in accordance with one or more embodiments of the disclosure.

FIG. 4 is a flow diagram depicting an illustrative method for determining, among other things, a mass flow measurement of a fluid flow in accordance with one or more embodiments of the disclosure.

### DETAILED DESCRIPTION OF EXAMPLE EMBODIMENTS

The systems and methods described herein facilitate determining, among other things, a mass flow measurement of a fluid flow. Certain embodiments may provide a technical solution for determining a mass flow measurement of a fluid flow (e.g., gas and/or liquid) without directly measuring the density, temperature, and/or pressure of the fluid flow. The systems and methods described herein may provide a quicker, cheaper, and/or more reliable mass flow measurement than current techniques. Moreover, the systems and methods described herein may provide real-time mass flow measurements.

In the oil and gas industry, it may be desirable to know the mass flow rate of a fluid flow. For example, a pipe (or other conduit) may include a fluid flowing therethrough. The fluid flow may be a single phase fluid flow and/or a fluid flow comprising varying compositions. It may be desirable to know the mass flow rate of the fluid flow. The systems and methods described herein may facilitate the determination of the mass flow rate of the fluid flow quickly and with substantially the same accuracy as typical volumetric flow meters. Although described with reference to the oil and gas industry, the systems and methods described herein may be implemented in any suitable context.

In an example embodiment, a system for determining a mass flow measurement of a fluid flow may include a pipe having a fluid flow therethrough. As noted above, the fluid flow may be a gas, a liquid, or a combination thereof. Moreover, the fluid flow may include various constituents. In some instances, the density of the fluid flow may vary. In other instances, the density of the fluid flow may be constant.

A first flow meter may be coupled to the pipe. In some instances, the first flow meter may be a differential pressure type flow meter. For example, the first flow meter may be an orifice flow meter, a venturi flow meter, or a reducer type flow meter. Other types of flow meters also may be used. A second flow meter may be coupled to the pipe in series with the first flow meter. In some instances, the second flow meter may be a linear velocity type flow meter. For example, the second flow meter may be a vortex flow meter, an ultrasonic flow meter, a magnetic flow meter, or a turbine flow meter. Other types of flow meters also may be used.

In certain embodiments, the second flow meter may be positioned in series downstream of the first flow meter relative to the fluid flow. In some instances, the first flow meter may be positioned in close proximity to the second flow meter. In other instances, the first flow meter and the second flow meter may be installed in reverse order. For example, the first flow meter may be positioned adjacent to the second flow meter. Depending on the context, the distance between the first flow meter and the second flow meter may vary. In some instances, the first flow meter and the second flow meter may be integral. That is, the first flow meter and the second flow meter may form a single device that is coupled to the pipe. In other instances, the first flow meter and the second flow meter may be separate components.

Information regarding the fluid flow from the first flow meter and the second flow meter, as well as known variables and/or constants associated with the first flow meter and the second flow meter, may be used to determine a mass flow rate of the fluid flow. For example:

mass flow rate=d*Q (1)

In equation (1), d is gas density, and Q is volume flow rate. For the first flow meter, which may be an orifice flow meter in certain embodiments:

Q=Y*C*A*sqrt(2*g*dp/d) (2)

In equation (2), Y is the gas compressibility factor, C is the orifice flow meter factor, A is the orifice bore cross-sectional area, g is gravity constant, and dp is the differential pressure across the orifice plate. From this, density may be determined as follows by solving for density in equation (2):

d=square(Y*C*A/Q)*2*g*dp (3)

The second flow meter, which may be a vortex flow meter, may measure volume flow rate (Q) directly. In this manner, the mass flow rate is given as:

mass flow=2*g*dp*square(Y*C*A)/Q (4)

In equation (4), dp is the differential pressure across the first flow meter, and Q is the volume flow rate of the second flow meter. That is, the fluid flow information from the first flow meter may comprise at least a differential pressure of the fluid flow across the first flow meter, and the fluid flow information from the second flow meter may comprise at least a volume flow rate of the fluid flow. Using the differential pressure of the fluid flow from the first flow meter and the volume flow rate of the fluid flow from the second flow meter, the mass flow rate of the fluid flow may be determined without directly measuring the density, temperature, and/or pressure of the fluid flow.

Although temperature and pressure are not used, it may be desirable that the first flow meter and the second flow meter are operating under the same operating conditions, i.e., temperature and pressure. In this manner, the first flow meter and the second flow meter may be positioned adjacent to each other about the pipe or in close proximity.

As noted above, the first flow meter may be a reducer type flow meter. In this embodiment, information regarding the fluid flow from the first flow meter and the second flow meter, as well as known variables and/or constants associated with the first flow meter and the second flow meter, may be used to determine a mass flow rate of the fluid flow. For example, differential static pressure across the reducer type flow meter is:

dp=d*v2*v2/(2%)−d*v1*v1/(2*g) (5)

In equation (5), dp is the differential static pressure across the reducer type flow meter, d is the flowing fluid density, v2 is the velocity at the throat, v1 is the velocity at the upstream pipe, and g is the gravity constant. The static pressure drop is the same as the velocity pressure drop. The velocity v1 and v2 are expressed by volumetric flow V measured by the second flow meter divided by the cross sectional area of the pipe and the throat. That is:

v2=V/A2 (6)

v1=V/A1 (7)

Equations (6) and (7) can be entered into equation (5):

dp=d*V*V/(2*g)*(1/(A2*A2)−1/(A1*A1)) (8)

From this, density may be determined as follows by solving for d in equation (8):

d=2*g*dp/(V*V)/(1/(A2*A2))−1/(A1*A1)) (9)

The second flow meter, which may be a vortex flow meter, measures volumetric flow (V) directly. In this manner, the mass flow rate is given as:

mass flow rate=2*g*dp/V/(1/(A2*A2))−1/(A1*A1)) (10)

After the concentric reducer portion of the second flow meter, the velocity distribution is uniform. Therefore, there is no need for a straight section before the second linear volumetric flow meter, which is normally required. Thus, this embodiment may be suitable for packaged designs.

The above determinations and calculations are for purposes of illustration and are not meant to be limiting. Other determinations, calculations, considerations, etc., may exist in other examples.

These and other embodiments of the disclosure will be described in more detail with reference to the accompanying drawings in the detailed description of the disclosure that follows. This brief introduction, including section titles and corresponding summaries, is provided for the reader's convenience and is not intended to limit the scope of the claims or the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

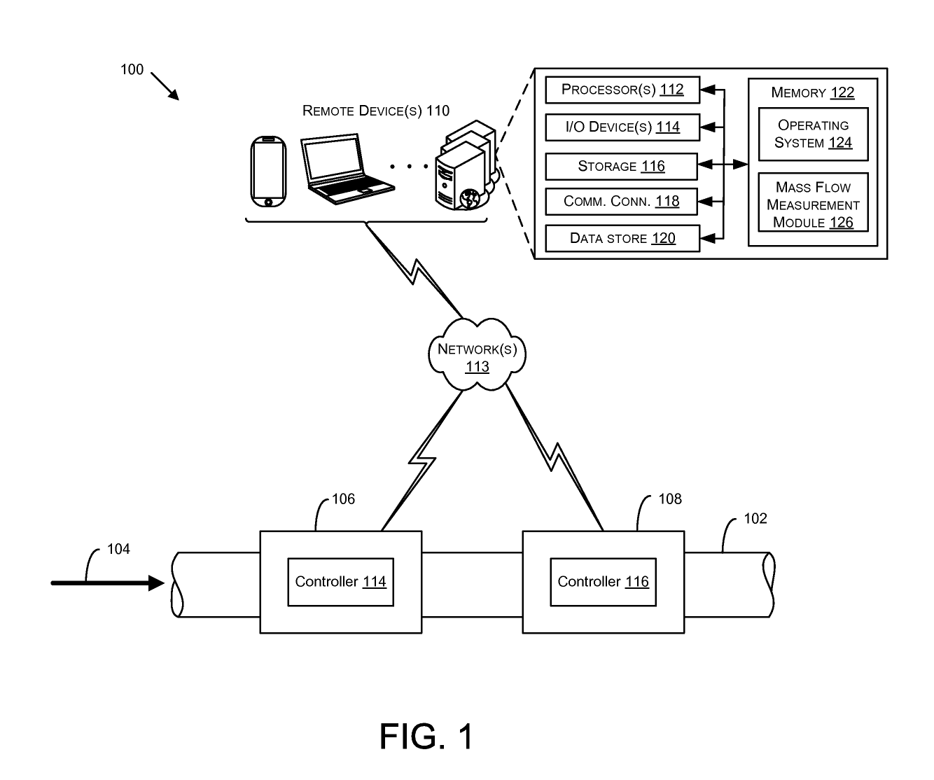

FIG. 1 schematically depicts a system 100 for determining a mass flow measurement of a fluid flow in accordance with one or more embodiments of the disclosure. In certain embodiments, the system 100 may include a pipe 102 having a fluid flow 104 therethrough. Moreover, the system 100 may include, but is not limited to, various computing and/or measurement devices, such as a first flow meter 106, a second flow meter 108, and/or one or more remote devices 110. Each of these devices may implement or facilitate the processes described herein. For example, the remote devices 110 may receive fluid flow information (such as one or more measurements) from the first flow meter 106 and/or the second flow meter 108, and utilize the fluid flow information to determine a mass flow measurement of the fluid flow 104, among other things.

In other embodiments, all or at least a portion of the determinations may be performed by the remote devices 110, the first flow meter 106, and/or the second flow meter 108. In such embodiments, the first flow meter 106 and/or the second flow meter 108 may send at least a portion of the fluid flow information to the remote devices 110 for processing, or the first flow meter 106 and/or the second flow meter 108 may perform a portion of the processes locally. In this way, the processes described herein may be distributed among various types and/or numbers of devices that may be configured to communicate over one or more networks 113 to implement or facilitate the processes described herein.

The remote devices 110 may be positioned close to the first flow meter 106, the second flow meter 108, and/or the pipe 102 or positioned at a remote location from the first flow meter 106, the second flow meter 108, and/or the pipe 102. Numerous other configurations may exist, at least some of which are described below.

As used herein, the term “device” may refer to any computing component that includes one or more processors that can be configured to execute computer-readable, computer-implemented, or computer-executable instructions. Example devices may include flow meters, personal computers, server computers, server farms, digital assistants, smart phones, tablets, personal digital assistants, digital tablets, smart cards, wearable computing devices, Internet appliances, application-specific circuits, microcontrollers, minicomputers, transceivers, kiosks, or other processor-based devices. The execution of suitable computer-implemented instructions by one or more processors associated with various devices may form special purpose computers or other particular machines that may implement or facilitate determining, among other things, the mass flow measurement of the fluid flow 104, as described herein.

The one or more networks 113 may include any number of wired or wireless networks that may enable various computing devices in the example system 100 to communicate with one another. In various embodiments, other networks, intranets, or combinations of different types of networks may be used including, but not limited to, the Internet, intranets, cable networks, cellular networks, landline-based networks, or other communication mediums connecting multiple computing devices to one another. The network 113 may allow for real-time, off-line, and/or batch transactions, as non-limiting examples, to be transmitted between or among the devices shown in the system 100. Due to network connectivity, methodologies as described herein may be practiced in the context of distributed computing environments. Other embodiments may not involve a network and may, for example, provide features on a single device or on devices that are directly connected to one another (for example, the first flow meter 106 may be directly connected to the second flow meter 108, and/or the remote devices 110, or vice versa, according to one configuration).

The pipe 102 may have fluid 104 flowing therethrough. In some instances, the pipe 102 may form part of a larger system in an oil and gas application, such as an oil and/or gas well, a refinement facility, a fracking operation, or the like. The fluid flow 104 may be a single phase. For example, the fluid flow 104 may comprise a liquid flow or a gas flow. The fluid flow 104 may be any gas or liquid.

The first flow meter 106 may be coupled to, attached, or otherwise in connection with the pipe 102. The first flow meter 106 may be configured to measure, among other things, a differential pressure of the fluid flow 104. In some instances, the first flow meter 106 is a differential pressure type flow meter. For example, the first flow meter 106 may be an orifice flow meter, a venturi flow meter, or a reducer type flow meter. Other types of flow meters also may be used. In some instances, the first flow meter 106 may include a controller 114 in communication with the network 113.

The second flow meter 108 may be coupled to, attached, or otherwise in connection with the pipe 102. The second flow meter 108 may be configured to measure, among other things, a volume flow rate of the fluid flow 104. The second flow meter 108 may be coupled to the pipe 102 in series with the first flow meter 106. In some instances, the second flow meter 108 may be a linear velocity type flow meter. For example, the second flow meter 108 may be a vortex flow meter, an ultrasonic flow meter, a magnetic flow meter, or a turbine flow meter. Other types of flow meters also may be used. In some instances, the second flow meter 108 may include a controller 116 in communication with the network 113.

In certain embodiments, the second flow meter 108 may be positioned in series downstream of the first flow meter 106 relative to the fluid flow 104. In some instances, the first flow meter 106 may be positioned in close proximity to the second flow meter 108. For example, the first flow meter 106 may be positioned adjacent to the second flow meter 108. Depending on the context, the distance between the first flow meter 106 and the second flow meter 108 may vary. In some instances, the first flow meter 106 and the second flow meter 108 may be integral. That is, the first flow meter 106 and the second flow meter 108 may form a single device that is coupled to the pipe 102. In other instances, the first flow meter 106 and the second flow meter 108 may be separate components.

In some embodiments, the first flow meter 106 and the second flow meter 108 may include controllers 114, 116. In one embodiment, the controllers 114, 116 may perform all or at least a portion of the functionality associated with the first flow meter 106, the second flow meter 108, and/or the remote devices 110. In some instances, the controllers 114, 116 may be integrated into the first flow meter 106 and/or the second flow meter 108. In other instances, the controllers 114, 116 may be distinct components from the first flow meter 106 and/or the second flow meter 108. The controllers 114, 116 may comprise at least one processor coupled to at least one memory. The first flow meter 106, the second flow meter 108, and/or the controllers 114, 116 may be in communication with the one or more networks 113. For example, the controllers 114, 116 may be transmitters or the like.

Each of the first flow meter 106, the second flow meter 108, and/or the remote devices 110 may include one or more processors configured to communicate with one or more memory devices and various other components or devices. For example, the remote devices 110 may include one or more devices that include one or more processors 112, one or more input/output (I/O) devices 114, storage 116, one or more communication connections 118, and one or more data stores 120. The one or more processors 112 may be implemented as appropriate in hardware, software, firmware, or any combination thereof.

The memory 122 associated with the remote devices 110 may store program instructions that are loadable and executable on the processor 112, as well as data generated during the execution of these programs. Depending on the configuration and type of remote devices 110 or flow meters 106, 108, the memory 122 may be volatile, such as random access memory (RAM), static random access memory (SRAM), dynamic random access memory (DRAM); or non-volatile, such as read-only memory (ROM), Electrically Erasable Programmable Read-Only Memory (EEPROM), flash memory, etc.

The memory 122 is an example of computer-readable storage media. For example, computer-readable storage media may include volatile and non-volatile, removable and non-removable media implemented in any method or technology for storage of information such as computer-readable instructions, data structures, program modules, or other data.

The storage 116 associated with the remote devices 110 may include removable and/or non-removable storage including, but not limited to, magnetic storage, optical disks, and/or tape storage. The disk drives and their associated computer-readable media may provide non-volatile storage of computer-readable instructions, data structures, program modules, and other data for the computing system.

The I/O devices 114 associated with the remote devices 110 may enable a user to interact with the first flow meter 106 and/or the second flow meter 108 to perform various functions. The I/O devices 114 may include, but are not limited to, a keyboard, a keypad, selector buttons/knobs/wheels, a mouse, a pen, a voice input device, a touch input device, a gesture detection or capture device, a display, a camera or an imaging device, speakers, and/or a printer.

The one or more communication connections 118 associated with the remote devices 110 may allow the remote devices 110 to communicate with other devices, such as the first flow meter 106 and/or the second flow meter 108, via the one or more networks 113. The communication connections 118 may include one or more antennas and one or more radios, which may include hardware and software for sending and/or receiving wired or wireless signals over the various types of networks 113 described above.

The one or more data stores 120 may store lists, arrays, databases, flat files, etc. In some implementations, the data store 120 may be stored in a memory external to the remote devices 110 but may be accessible via one or more networks 113, such as with a cloud storage service. The data store 120 may store information that may facilitate the processes described herein, such as the determination of a mass flow measurement of a fluid flow. Non-limiting examples of such information are described herein.

Turning to the contents of the memory 122 in more detail, the memory 122 may include an operating system 124 and one or more application programs or services for implementing the features disclosed herein, such as a mass flow measurement module 126. The mass flow measurement module 126 may be configured to receive, store, determine, identify, and/or provide information associated with the first flow meter 106 and the second flow meter 108. For example, the mass flow measurement module 126 may be configured to receive and/or determine a pressure differential of the fluid flow 104 from the first flow meter 106. Moreover, the mass flow measurement module 126 may be configured to receive and/or determine a volume flow rate of the fluid flow 104 from the second flow meter 108.

The mass flow measurement module 126 may be further configured to determine a density of the fluid flow 104. For example, the mass flow measurement module 126 may be configured to back-calculate the density of the fluid flow 104 based on the pressure differential of the fluid flow 104 and the volume flow rate of the fluid flow 104. Based on the density of the fluid flow 104, the mass flow measurement module 126 may be configured to determine a mass flow rate of the fluid flow 104. In some instances, one or more known variables or constants associated with the first flow meter 106 and/or the second flow meter 108 may be determined using known tables or equations based on one or more known properties of the first flow meter 106 and/or the second flow meter 108. These known variables or constants may be used when determining the density and mass flow rate of the fluid flow 104.

The above processes described in association with the mass flow measurement module 126 are for purposes of illustration and are not meant to be limiting. Various other processes may be performed by the mass flow measurement module 126 and/or one or more other modules.

Although the above operations are described as being implemented by the remote devices 110, they may equally be implemented at one or more of the first flow meter 106, the second flow meter 108, and/or by a third-party computing device in communication with the one or more networks 113 or any combination thereof. That is, any device or combination of devices may be used to implement the above operations. The example architecture is but a few of many. The specific architectures, features, and acts are disclosed as example illustrative forms of implementing the embodiments.

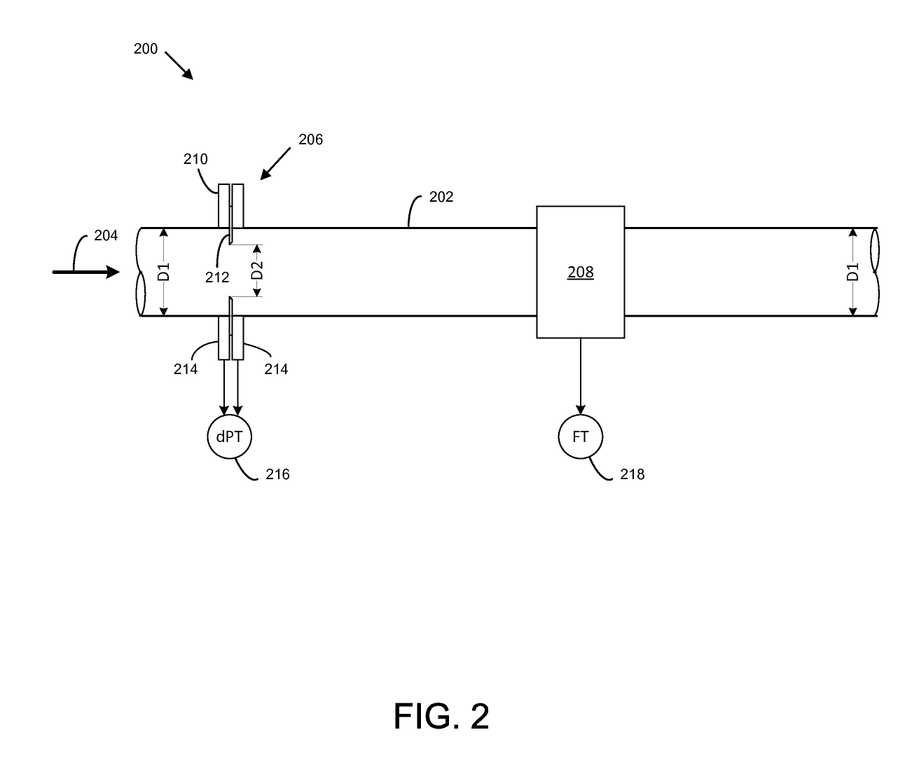

FIG. 2 depicts an example system 200 as may be used herein. For example, the system 200 may be implemented and/or incorporated into the system 100 of FIG. 1. The system 200 may include a pipe 202 having a fluid flow 204 therethrough. The system 200 also may include a first flow meter 206 and a second flow meter 208. The first flow meter 206 may be coupled to the pipe 202. The first flow meter 206 may be configured to measure, among other things, a differential pressure of the fluid flow 204. In this embodiment, the first flow meter 206 may be an orifice flow meter. For example, the first flow meter 206 may include a flange 210 and an orifice plate 212. The first flow meter 206 also may include pressure taps 214 positioned upstream and downstream of the orifice plate 212. The pipe 202 may include a first diameter D1, and the orifice plate 212 may form a second diameter D2. In some instances, the second diameter may be smaller than the first diameter.

A differential pressure transmitter 216 may be in communication with the first flow meter 206. For example, the differential pressure transmitter 216 may be in communication with the pressure taps 214 so as to measure a pressure differential in the fluid flow 204. In this manner, the differential pressure transmitter 216 may identify, measure, receive, or determine a pressure differential of the fluid flow 204. In some instances, the differential pressure transmitter 216 may be a controller or the like.

The second flow meter 208 may be coupled to the pipe 202. The second flow meter 208 may be configured to measure, among other things, a volume flow rate of the fluid flow 204. The second flow meter 208 may be coupled to the pipe 202 in series with the first flow meter 206. In some instances, the second flow meter 208 may be a linear velocity type flow meter. For example, the second flow meter 208 may be a vortex flow meter, an ultrasonic flow meter, a magnetic flow meter, or a turbine flow meter. Other types of flow meters also may be used. In some instances, the second flow meter 208 may be in communication with a liner volumetric flow transmitter 218. The liner volumetric flow transmitter 218 may identify, measure, receive, or determine a volume flow rate of the fluid flow 204. In some instances, the liner volumetric flow transmitter 218 may be a controller or the like.

Based on the differential pressure as determined by the first flow meter 206 and the volume flow rate as determined by the second flow meter 208, a density of the fluid flow 204 may be determined. In addition, using the density of the fluid flow 204, a mass flow rate of the fluid flow 204 may be determined. For example, the volume flow rate of the fluid flow 204 as determined by the second flow meter 208 may be multiplied by the density of the fluid flow 204 to determine the mass flow rate of the fluid flow 204.

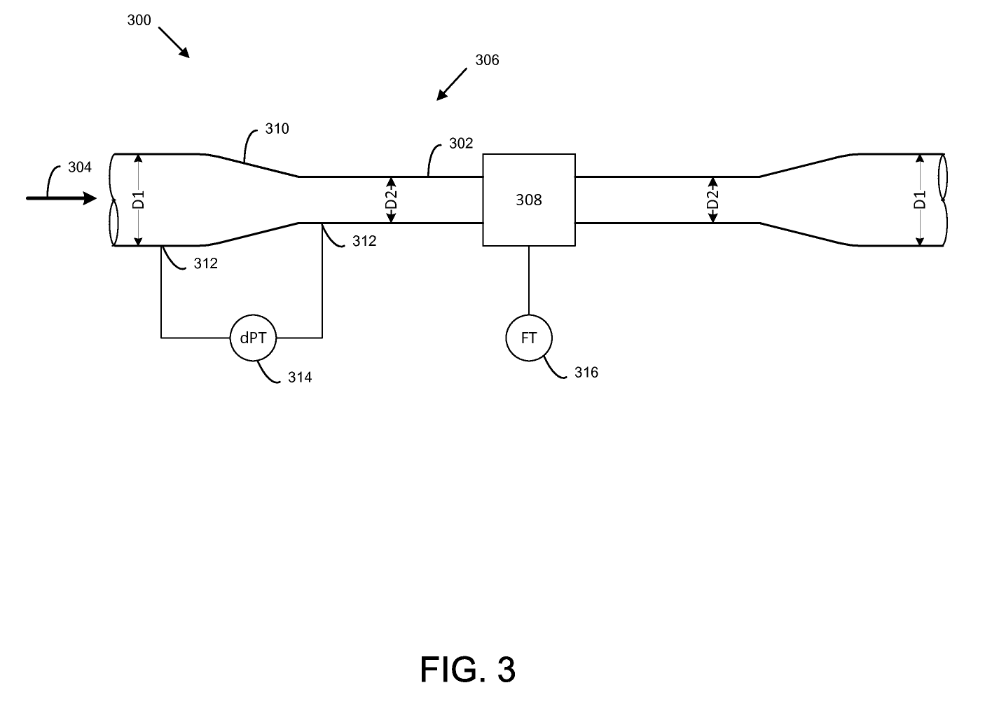

FIG. 3 depicts an example system 300 as may be used herein. For example, the system 300 may be implemented and/or incorporated into the system 100 of FIG. 1. The system 300 may include a pipe 302 having a fluid flow 304 therethrough. The system 300 also may include a first flow meter 306 and a second flow meter 308. The first flow meter 306 may be coupled to the pipe 302. The first flow meter 306 may be configured to measure, among other things, a differential pressure of the fluid flow 304. In this embodiment, the first flow meter 306 may be a reducer type flow meter. For example, the first flow meter 306 may include a concentric reducer portion 310. For example, the pipe 302 may include a first diameter D1 and a second diameter D2. The concentric reducer portion 310 may be positioned between the first diameter and the second diameter. In some instances, the second diameter may be smaller than the first diameter. The first flow meter 306 also may include pressure taps 312. The pressure taps 312 may be positioned upstream and downstream of the concentric reducer portion 310.

A differential pressure transmitter 314 may be in communication with the first flow meter 306. For example, the differential pressure transmitter 314 may be in communication with the pressure taps 312 so as to measure a pressure differential in the fluid flow 304. In this manner, the differential pressure transmitter 314 may identify, measure, receive, or determine a pressure differential of the fluid flow 304. In some instances, the differential pressure transmitter 314 may be a controller or the like.

The second flow meter 308 may be coupled to the pipe 302. The second flow meter 308 may be configured to measure, among other things, a volume flow rate of the fluid flow 304. The second flow meter 308 may be coupled to the pipe 302 in series with the first flow meter 306. In some instances, the second flow meter 308 may be a linear velocity type flow meter. For example, the second flow meter 308 may be a vortex flow meter, an ultrasonic flow meter, a magnetic flow meter, or a turbine flow meter. Other types of flow meters also may be used. In some instances, the second flow meter 308 may be in communication with a liner volumetric flow transmitter 316. The liner volumetric flow transmitter 316 may identify, measure, receive, or determine volume flow rate of the fluid flow 304. In some instances, the liner volumetric flow transmitter 316 may be a controller or the like.

Based on the differential pressure as determined by the first flow meter 306 and the volume flow rate as determined by the second flow meter 308, a density of the fluid flow 304 may be determined. In addition, using the density of the fluid flow 304, a mass flow rate of the fluid flow 304 may be determined. For example, the volume flow rate of the fluid flow 304 as determined by the second flow meter 308 may be multiplied by the density of the fluid flow 304 to determine the mass flow rate of the fluid flow 304.

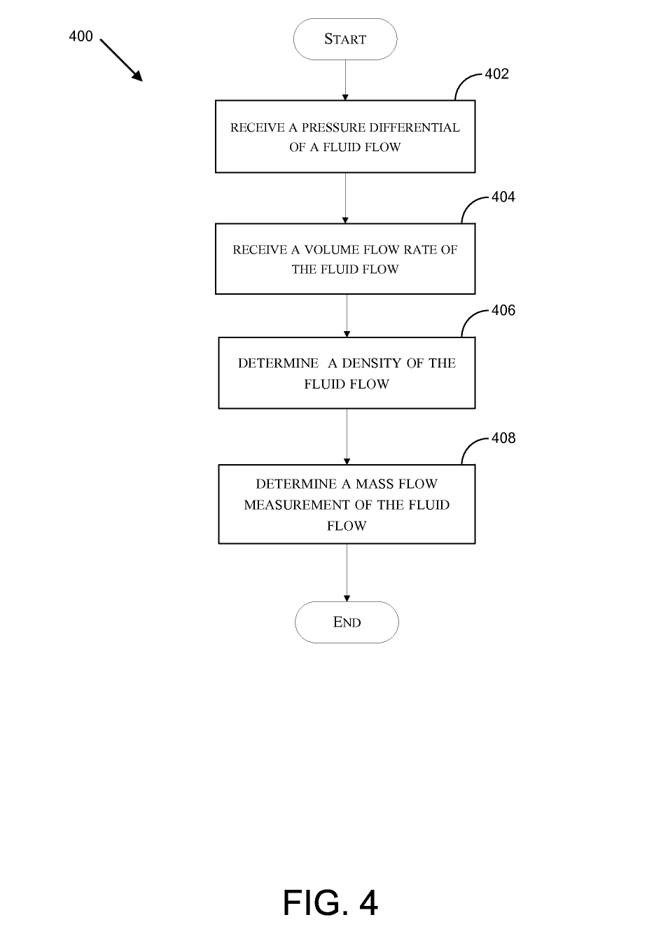

FIG. 4 is a flow diagram depicting an illustrative method 400 for determining a mass flow measurement of a fluid flow in accordance with one or more embodiments of the disclosure. In one embodiment, all or a portion of the illustrative method 400 may be performed by the remote devices 110 in FIG. 1. Further, all or a portion of the illustrative method 400 may be performed by any combination of the remote devices 110, the first flow meter 106, the second flow meter 108, and/or a third-party commuting device.

The illustrative method 400 may begin at block 402, where a pressure differential of a fluid flow may be received. For example, a first flow meter may determine a pressure differential of a fluid flow. In some instances, the first flow meter may be a differential pressure type flow meter. For example, the first flow meter may be an orifice flow meter, a venturi flow meter, or a reducer type flow meter. Other types of flow meters also may be used.

At block 404 of the method 400, a volume flow rate of the fluid flow may be received. For example, a second flow meter may determine a volume flow rate of the fluid flow. In some instances, the second flow meter may be a linear velocity type flow meter. For example, the second flow meter may be a vortex flow meter, an ultrasonic flow meter, a magnetic flow meter, or a turbine flow meter. Other types of flow meters also may be used.

A density of the fluid flow may be determined at block 406 of the method 400. For example, based on the differential pressure as determined by the first flow meter and the volume flow rate as determined by the second flow meter, a density of the fluid flow may be determined. The density may be determined by back-calculating the density based on the differential pressure as determined by the first flow meter and the volume flow rate as determined by the second flow meter. One or more known variables or constants associated with the first flow meter and the second flow meter may be taken into consideration when determining the density of the fluid flow. Moreover, at block 408 of the method 400, a mass flow measurement of the fluid flow may be determined. For example, using the density of the fluid flow, a mass flow rate of the fluid flow may be determined. In some instances, the volume flow rate of the fluid flow as determined by the second flow meter may be multiplied by the density of the fluid flow to determine the mass flow rate of the fluid flow.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system, comprising:
a pipe having a fluid flow therethrough;
a first flow meter coupled to the pipe;
a second flow meter coupled to the pipe in series with the first flow meter; and
a computer in communication with the first flow meter and the second flow meter, wherein the computer comprises:
at least one memory that stores computer-executable instructions; and
at least one processor configured to access the at least one memory, wherein the at least one processor is configured to execute the computer-executable instructions to:
receive fluid flow information from the first flow meter;
receive fluid flow information from the second flow meter; and
determine, based at least in part on the fluid flow information from the first flow meter and the fluid flow information from the second flow meter, a mass flow measurement of the fluid flow.

2. The system of claim 1, wherein the first flow meter comprises a differential pressure type flow meter.

3. The system of claim 2, wherein the first flow meter comprises an orifice flow meter or a venturi flow meter.

4. The system of claim 1, wherein the second flow meter comprises a linear velocity type flow meter.

5. The system of claim 4, wherein the second flow meter comprises at least one of a vortex flow meter, an ultrasonic flow meter, a magnetic flow meter, or a turbine flow meter.

6. The system of claim 1, wherein the first flow meter is positioned in close proximity to the second flow meter.

7. The system of claim 1, wherein the first flow meter is positioned upstream from the second flow meter relative to the fluid flow.

8. A method, comprising:
receiving, by at least one processor coupled to at least one memory, fluid flow information from a first flow meter;
receiving, by the at least one processor, fluid flow information from a second flow meter; and
determining, by the at least one processor and based at least in part on the fluid flow information from the first flow meter and the fluid flow information from the second flow meter, a mass flow measurement.

9. The method of claim 8, wherein the fluid flow information from the first flow meter comprises at least a differential pressure of the fluid flow across the first flow meter.

10. The method of claim 8, wherein the fluid flow information from the second flow meter comprises at least a volume flow rate of the fluid flow.

11. The method of claim 8, wherein the first flow meter and the second flow meter are positioned in series about a pipe.

12. The method of claim 8, wherein the first flow meter comprises a differential pressure type flow meter.

13. The method of claim 8, wherein the second mass flow meter comprises a linear velocity type flow meter or a venturi flow meter.

14. The method of claim 8, wherein the first flow meter is positioned in close proximity to the second flow meter.

15. A method, comprising:
identifying, by at least one processor coupled to at least one memory, one or more known variables associated with a first flow meter, wherein the first flow meter is coupled to a pipe having a fluid flow therethrough;
receiving, by the at least one processor, fluid flow information from the first flow meter;
identifying, by the at least one processor, one or more known variables associated with a second flow meter, wherein the second flow meter is coupled to the pipe in series with the first flow meter;
receiving, by the at least one processor, fluid flow information from the second flow meter;
determining, by the at least one processor and based at least in part on the fluid flow information from the first flow meter, the fluid flow information from the second flow meter, the one or more known variables associated with the first flow meter, and the one or more variables associated with the second flow meter, a density of the fluid flow; and
determining, by the at least one processor and based at least in part on the density, a mass flow measurement of the fluid flow.

16. The method of claim 15, wherein the fluid flow information from the first flow meter comprises at least a differential pressure of the fluid flow across the first flow meter.

17. The method of claim 15, wherein the fluid flow information from the second flow meter comprises at least a volume flow rate of the fluid flow.

18. The method of claim 15, wherein the first flow meter comprises a differential pressure type flow meter.

19. The method of claim 15, wherein the second flow meter comprises a linear velocity type flow meter.

20. The method of claim 15, wherein the first flow meter is positioned in close proximity to the second flow meter.
